(19) United States
(12) Patent Application Publication
(10) Pub. No.: US 2024/0209524 A1
(43) Pub. Date: Jun. 27, 2024

(54) ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/599,718

(22) Filed: Mar. 8, 2024

Related U.S. Application Data
(63) Continuation of application No. PCT/JP2023/004777, filed on Feb. 13, 2023.

(30) Foreign Application Priority Data
Mar. 15, 2022 (JP) 2022-040696

(51) Int. Cl. C25B 9/63

(52) U.S. Cl. CPC C25B 9/63

(57) ABSTRACT

An electrochemical cell includes a metallic plate, a cell body, and a first reinforcing portion. The metallic plate includes a first principal surface, a second principal surface, and a through hole. The cell body includes a first electrode layer, a second electrode layer, and an electrolyte layer. The electrolyte layer is disposed between the first electrode layer and the second electrode layer. The cell body is disposed on the first principal surface of the metallic plate. The first reinforcing portion is provided on an inner wall surface of the through hole along a circumferential direction of the through hole. The first reinforcing portion is configured to reinforce the inner wall surface of the through hole.

### CROSS-REFERENCE TO RELATED APPLICATION

This is a continuation of PCT/JP2023/004777, filed Feb. 13, 2023, which claims priority from Japanese Application No. 2022-040696, filed Mar. 15, 2022, the entire contents of which are hereby incorporated by reference.

### TECHNICAL FIELD

The present invention relates to an electrochemical cell.

### BACKGROUND ART

Supporting a cell body by a metallic plate has been known as a structure for an electrochemical cell such as an electrolytic cell, a fuel cell, or so forth. For example, an electrochemical cell disclosed in WO2018/181926 is structured such that an electrode layer, an electrolyte layer, and a counter electrode layer are laminated on a metallic plate in this order. The metallic plate includes through holes for supplying gas to the electrode layer.

### SUMMARY

### Technical Problems

When repeatedly operated and stopped, the electrochemical cell configured as described above goes through a thermal cycle, whereby the metallic plate repeatedly expands and contracts. This results in a drawback that the through holes in the metallic plate deform, whereby cracking, peeling off, or so forth occurs in the electrode layer disposed on the through holes.

In view of this, it is an object of the present invention to inhibit cracking or peeling-off from occurring in the electrode layer disposed on the metallic plate.

### Solution to Problems

An electrochemical cell according to an aspect of the present invention includes a metallic plate, a cell body, and a first reinforcing portion. The metallic plate includes a first principal surface, a second principal surface, and a through hole. The cell body includes a first electrode layer, a second electrode layer, and an electrolyte layer. The electrolyte layer is disposed between the first electrode layer and the second electrode layer. The cell body is disposed on the first principal surface of the metallic plate. The first reinforcing portion is provided on an inner wall surface of the through hole along a circumferential direction of the through hole. The first reinforcing portion is configured to reinforce the inner wall surface of the through hole.

According to the configuration, the first reinforcing portion is provided on the inner wall surface of the through hole along the circumferential direction of the through hole. Because of this, it is made possible to inhibit deformation of the through hole. As a result, it is made possible to inhibit cracking or peeling-off from occurring in the first electrode layer disposed on the metallic plate.

Preferably, the first reinforcing portion is made of a material higher in Young's modulus than the metallic plate.

Preferably, the first reinforcing portion is disposed on an end close to the second principal surface on the inner wall surface of the through hole.

Preferably, the first reinforcing portion is made in shape of an annulus.

Preferably, the electrochemical cell further includes a second reinforcing portion. The second reinforcing portion is disposed closer to the first principal surface than the first reinforcing portion. The second reinforcing portion is provided on the inner wall surface of the through hole along the circumferential direction of the through hole. The second reinforcing portion is configured to reinforce the inner wall surface of the through hole.

Preferably, the second reinforcing portion is made of a material higher in Young's modulus than the metallic plate.

Preferably, the first reinforcing portion is made of ceramics.

Preferably, the first reinforcing portion is made of metal.

### Advantageous Effects of Invention

According to the present invention, it is made possible to inhibit cracking or peeling-off from occurring in the electrode layer disposed on the metallic plate.

### BRIEF DESCRIPTION OF THE DRAWINGS

FIG. 1 is a cross-sectional view of an electrolytic cell.

FIG. 2 is a plan view of a metallic plate.

FIG. 3 is an enlarged cross-sectional view of details of the electrolytic cell.

FIG. 4 is an enlarged bottom view of the metallic plate.

FIG. 5 is a cross-sectional view of an electrolytic cell according to a modification.

FIG. 6 is an enlarged cross-sectional view of details of an electrolytic cell according to another modification.

FIG. 7 is an enlarged cross-sectional view of details of an electrolytic cell according to yet another modification.

FIG. 8 is an enlarged cross-sectional view of details of an electrolytic cell according to still another modification.

### DESCRIPTION OF EMBODIMENTS

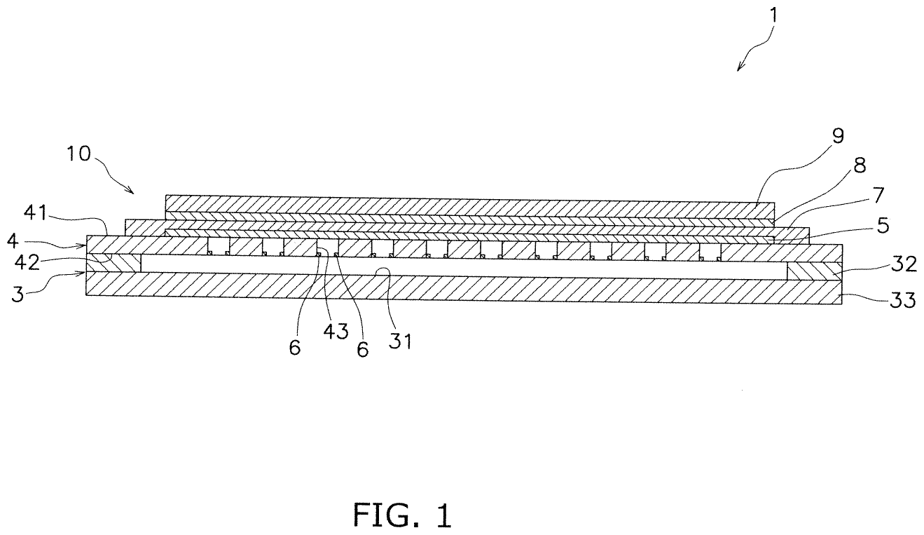

An electrolytic cell (exemplary electrochemical cell) according to the present preferred embodiment will be hereinafter explained with reference to drawings. It should be noted that in the present preferred embodiment, explanation will be made with a solid oxide electrolytic cell (SOEC) as an exemplary electrolytic cell. FIG. 1 is a cross-sectional view of the electrolytic cell. In the following explanation, the term “solid oxide electrolytic cell” will be abbreviated as “cell” on an as-needed basis.

As shown in FIG. 1, a cell 1 includes a cell body 10, a metallic plate 4, and first reinforcing portions 6. Besides, the cell 1 further includes a channel member 3.

### [Channel Member 3]

The channel member 3 is joined to the metallic plate 4. The channel member 3 includes a channel 31. The channel 31 is provided on a surface of the channel member 3 in opposition to the metallic plate 4. In the present preferred embodiment, the channel 31 is provided on the upper surface of the channel member 3. The channel 31 is opened toward the metallic plate 4. The channel 31 is connected to a manifold or so forth (not shown in the drawings). In the present preferred embodiment, the channel 31 is supplied with raw material gas.

The channel member 3 can be made of, for instance, an alloy material. The channel member 3 may be made of the same material as the metallic plate 4.

The channel member 3 includes a frame 32 and an inter-connector 33. The frame 32 is an annular member laterally surrounding the channel 31. The frame 32 is joined to the metallic plate 4. The inter-connector 33 is a plate-shaped member electrically connecting in series the electrolytic cell 1 to an external power supply or another electrolytic cell. The inter-connector 33 is joined to the frame 32.

In the channel member 3 according to the present preferred embodiment, the frame 32 and the inter-connector 33 are separated as different members but may be integrated as a single member.

### [Metallic Plate 4]

The metallic plate 4 supports the cell body 10. In the present preferred embodiment, the metallic plate 4 is made in shape of a plate. The metallic plate 4 may be made in shape of a flat plate or a curved plate. The metallic plate 4 is not particularly limited in thickness if the cell 1 can be ensured in strength; however, the metallic plate 4 can be set to have a thickness of, for instance, greater than or equal to 0.1 mm and less than or equal to 2.0 mm.

The metallic plate 4 includes a first principal surface 41, a second principal surface 42, and a plurality of through holes 43. The first principal surface 41 of the metallic plate 4 supports the cell body 10. The second principal surface 42 of the metallic plate 4 is opposed to the channel 31. It should be noted that in the present preferred embodiment, the upper surface of the metallic plate 4 corresponds to the first principal surface 41, whereas the lower surface of the metallic plate 4 corresponds to the second principal surface 42. The frame 32 of the channel member 3 is connected to the second principal surface 42 of the metallic plate 4.

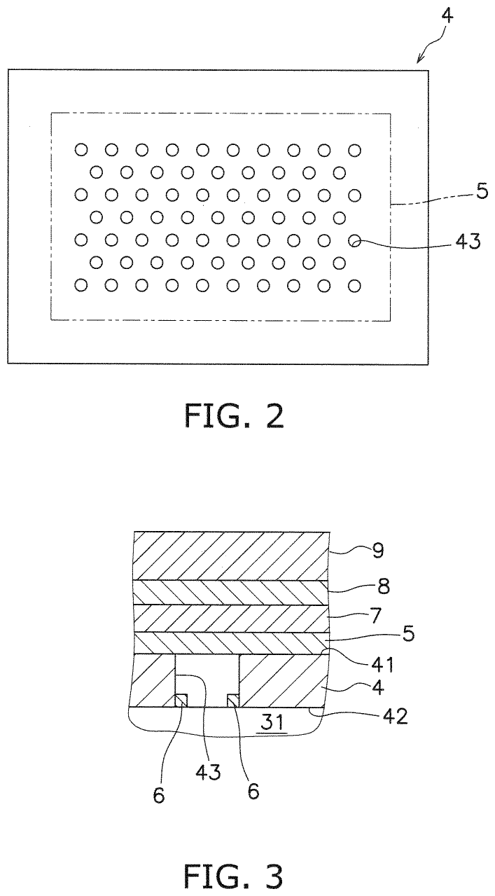

As shown in FIG. 2, the metallic plate 4 is made in shape of a rectangle in a plan view. It should be noted that the metallic plate 4 may be made in shape of another shape such as a circular shape. The plural through holes 43 are aligned in both lengthwise and widthwise directions of the metallic plate 4. The plural through holes 43 are provided in a region, joined to a hydrogen electrode layer 5 (to be described), in the metallic plate 4. The through holes 43 are opened in the first principal surface 41. Besides, the through holes 43 are opened in the second principal surface 42 as well. In other words, the through holes 43 extend from the first principal surface 41 to the second principal surface 42 in the thickness direction of the metallic plate 4. The through holes 43 penetrate the metallic plate 4 in the thickness direction. The through holes 43 are communicated with the channel 31 of the channel member 3. The raw material gas, flowing through the channel 31, is supplied to the hydrogen electrode layer 5 via the through holes 43.

Each through hole 43 is approximately made in shape of a circle in a plan view. In the plan view, each through hole 43 can be set to have an area of, for instance, greater than or equal to 0.00005 mm² and less than or equal to 1 mm². Besides, each through hole 43 can be set to have a diameter of, for instance, greater than or equal to 10 μm and less than or equal to 1000 μm. It should be noted that each through hole 43 may be made in shape of a rectangle in the plan view. Besides, each through hole 43 has a height greater in magnitude than the thickness of the hydrogen electrode layer 5. Each through hole 43 can be set to have a height of, for instance, greater than or equal to 100 μm and less than or equal to 2000 μm. It should be noted that the term “height of each through hole 43” means the up-and-down directional dimension of each through hole 43 in FIG. 1.

The through holes 43 can be perforated by machining processing (e.g., punching), laser processing, chemical processing (e.g., etching), or so forth. It is also possible to use porous metal for the metallic plate 4 to make the metallic plate 4 have gas permeability.

The metallic plate 4 is made of a metallic material. For example, the metallic plate 4 is made of an alloy material containing Cr (Chromium). Fe—Cr-based alloy steel (stainless steel, etc.), Ni—Cr-based alloy steel, or so forth can be used as the metallic material described above. The metallic plate 4 is not particularly limited in content rate of Cr but can be set to contain Cr at a content rate of greater than or equal to 4 mass % and less than or equal to 30 mass %.

The metallic plate 4 may contain Ti (titanium) and Zr (zirconium). The metallic plate 4 is not particularly limited in content rate of Ti but can be set to contain Ti at a content rate of greater than or equal to 0.01 mol % and less than or equal to 1.0 mol %. The metallic plate 4 is not particularly limited in content rate of Zr but can be set to contain Zr at a content rate of greater than or equal to 0.01 mol % and less than or equal to 0.4 mol %. The metallic plate 4 may contain Ti in the form of TiO₂ (titania) and may contain Zr in the form of ZrO₂ (zirconia).

The metallic plate 4 may be provided with an oxide film on the surface thereof. Specifically, the metallic plate 4 may be provided with a chromium oxide film on the surface thereof. The oxide film covers at least part of the surface of the metallic plate 4. The oxide film is only required to cover at least part of the surface of the metallic plate 4 but may approximately cover the entirety of the surface of the metallic plate 4. Besides, the oxide film may cover the inner wall surface of each through hole 43. The oxide film is not particularly limited in thickness but can be set to have a thickness of, for instance, greater than or equal to 0.1 μm and less than or equal to 20 μm.

### [Cell Body 10]

As shown in FIG. 1, the cell body 10 is disposed on the first principal surface 41 of the metallic plate 4. The cell body 10 includes the hydrogen electrode layer 5 (cathode), an electrolyte layer 7, a reaction preventing layer 8, and an oxide electrode layer 9 (anode). The hydrogen electrode layer 5, the electrolyte layer 7, the reaction preventing layer 8, and the oxide electrode layer 9 are laminated in this order from the metallic plate 4 side. It should be noted that the cell body 10 may not include the reaction preventing layer 8. Besides, the hydrogen electrode layer 5 is an exemplary first electrode layer in the present invention, whereas the oxide electrode layer 9 is an exemplary second electrode layer in the present invention.

### [Hydrogen Electrode Layer 5]

The hydrogen electrode layer 5 is supported by the metallic plate 4. When described in detail, the hydrogen electrode layer 5 is disposed on the first principal surface 41 of the metallic plate 4. The hydrogen electrode layer 5 can be set to have a thickness t of, for instance, greater than or equal to 1 μm and less than or equal to 100 μm. The hydrogen electrode layer 5 is smaller in thickness than the metallic plate 4. As shown in FIG. 2, the hydrogen electrode layer 5 is disposed to cover the region, provided with the plural through holes 43, in the metallic plate 4.

It is preferable for the hydrogen electrode layer 5 to be porous. The hydrogen electrode layer 5 is not particularly limited in porosity but can be set to have a porosity of, for instance, greater than or equal to 20% and less than or equal to 70%.

The hydrogen electrode layer 5 is made of a porous material with electron conductivity. The hydrogen electrode layer 5 may have oxide ion conductivity. The hydrogen electrode layer 5 can be made of, for instance, one selected from the group consisting of 8 mol % yttria-stabilized zirconia (8YSZ), calcia-stabilized zirconia (CSZ), scandia-stabilized zirconia (ScSZ), gadolinium-doped ceria (GDC), samarium-doped ceria (SDC), (La, Sr) (Cr, Mn)O₃, (La, Sr)TiO₃, Sr₂(Fe, Mo)₂O₆, (La, Sr)VO₃, (La, Sr)FeO₃, a mixed material obtained by a combination of two or more of the group, or a composite material composed of one or more of the group and NiO.

The hydrogen electrode layer 5 is not particularly limited in method of formation and can be formed by any of the methods such as firing, spray coating, PVD, and CVD.

The hydrogen electrode layer 5 is supplied with the raw material gas via the through holes 43. The raw material gas contains CO₂ and H₂O. The hydrogen electrode layer 5 generates H₂, CO, and O²⁻ from the raw material gas by electrochemical reactions of co-electrolysis expressed by the following equation (1).

$$- Hydrogen electrode layer 5 : {CO}_{2} + {H}_{2} O + 4 {e}^{-} \to CO + {H}_{2} + 2 {O}^{2 -} \qquad ( 1 )$$

### [Electrolyte Layer 7]

As shown in FIG. 1, the electrolyte layer 7 is disposed between the hydrogen electrode layer 5 and the oxide electrode layer 9. In the present preferred embodiment, the cell body 10 includes the reaction preventing layer 8; hence, the electrolyte layer 7 is interposed between the hydrogen electrode layer 5 and the reaction preventing layer 8. The electrolyte layer 7 is not particularly limited in thickness but can be set to have a thickness of, for instance, greater than or equal to 3 μm and less than or equal to 50 μm.

In the present preferred embodiment, the electrolyte layer 7 is disposed to cover the entirety of the hydrogen electrode layer 5. The electrolyte layer 7 is joined at an outer peripheral part thereof to the first principal surface 41 of the metallic plate 4. Airtightness can be thereby ensured between the hydrogen electrode layer 5 side and the oxide electrode layer 9 side; hence, sealing between the metallic plate 4 and the electrolyte layer 7 is not required to be made anew.

The electrolyte layer 7 serves to transmit O²⁻ generated in the hydrogen electrode layer 5 to the oxide electrode layer 9. The electrolyte layer 7 has oxide ion conductivity. The electrolyte layer 7 is made of a dense material. The electrolyte layer 7 has a porosity of, approximately, greater than or equal to 0% and less than or equal to 7%. The electrolyte layer 7 is a fired body made of a dense material having ion conductivity without electron conductivity. The electrolyte layer 7 can be made of, for instance, 8YSZ, GDC, ScSZ, SDC, LSGM (lanthanum gallate), or so forth.

The electrolyte layer 7 is not particularly limited in method of formation but can be formed by any of the methods such as firing, spray coating, PVD, and CVD.

### [Reaction Preventing Layer 8]

The reaction preventing layer 8 is disposed on the electrolyte layer 7. The reaction preventing layer 8 is interposed between the electrolyte layer 7 and the oxide electrode layer 9. The reaction preventing layer 8 is not particularly limited in thickness but can be set to have a thickness of, for instance, greater than or equal to 3 μm and less than or equal to 50 μm. The reaction preventing layer 8 inhibits a reaction layer with high electric resistance from being formed by reactions between the material of which the oxide electrode layer 9 is made and the material of which the electrolyte layer 7 is made.

The reaction preventing layer 8 is made of a material with oxide ion conductivity. The reaction preventing layer 8 can be made of a ceria-based material such as GDC or SDC. The reaction preventing layer 8 is not particularly limited in porosity but can be set to have a porosity of, for instance, greater than or equal to 0% and less than or equal to 50%. The reaction preventing layer 8 is not particularly limited in method of formation but can be formed by any of the methods such as firing, spray coating, PVD, and CVD.

### [Oxide Electrode Layer 9]

The oxide electrode layer 9 is disposed on the opposite side of the hydrogen electrode layer 5 with reference to the electrolyte layer 7. In the present preferred embodiment, the cell 1 includes the reaction preventing layer 8; hence, the oxide electrode layer 9 is disposed on the reaction preventing layer 8.

It is preferable for the oxide electrode layer 9 to be porous. The oxide electrode layer 9 is not particularly limited in porosity but can be set to have a porosity of, for instance, greater than or equal to 20% and less than or equal to 70%. The oxide electrode layer 9 is not particularly limited in thickness but can be set to have a thickness of, for instance, greater than or equal to 10 μm and less than or equal to 100 μm.

The oxide electrode layer 9 is made of a porous material having both oxide ion conductivity and electron conductivity. The oxide electrode layer 9 can be made of, for instance, a composite material composed of an oxide ion conductive material (GDC, etc.) and at least one selected from the group consisting of (La, Sr) (Co, Fe)O₃, (La, Sr)FeO₃, La (Ni, Fe)O₃, (La, Sr)CoO₃, and (Sm, Sr)CoO₃.

The oxide electrode layer 9 is not particularly limited in method of formation but can be formed by any of the methods such as firing, spray coating, PVD, and CVD.

The oxide electrode layer 9 generates O₂ from O²⁻ transmitted thereto from the hydrogen electrode layer 5 via the electrolyte layer 7 by chemical reactions expressed by the following equation (2).

$$- Oxide electrode layer 9 : 2 {O}^{2 -} \to {O}_{2} + 4 {e}^{-} \qquad ( 2 )$$

### [First Reinforcing Portions 6]

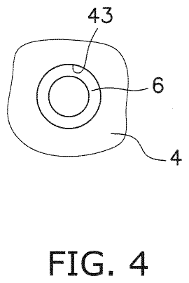

FIG. 3 is a cross-sectional view of details of each through hole and the surroundings thereof, whereas FIG. 4 is a bottom view of each through hole seen from the second principal surface side. As shown in FIGS. 3 and 4, each first reinforcing portion 6 is provided on the inner wall surface of each through hole 43 along the circumferential direction of each through hole 43. Specifically, each first reinforcing portion 6 is made in shape of an annulus. In other words, each first reinforcing portion 6 continuously extends along the circumferential direction. It should be noted that each first reinforcing portion 6 may intermittently extend along the circumferential direction. It should be noted that each first reinforcing portion 6 may not be directly provided on the inner wall surface of each through hole 43. For example, when an oxide film is provided on the inner wall surface of each through hole 43, each first reinforcing portion 6 is provided on the oxide film.

Each first reinforcing portion 6 is disposed on an end close to the second principal surface 42 on the inner wall surface of each through hole 43. When described in detail, each through hole 43 includes an end close to the first principal surface 41 and the end close to the second principal surface 42 in the axial direction thereof. Then, each first reinforcing portion 6 is provided on one of both axial ends of each through hole 43, i.e., the end close to the second principal surface 42, without being provided on the other, i.e., the end close to the first principal surface 41. It should be noted that each first reinforcing portion 6 may be disposed close to the first principal surface 41.

Each first reinforcing portion 6 protrudes from the inner wall surface of each through hole 43 toward the center of each through hole 43. Each first reinforcing portion 6 has a height of, for instance, greater than or equal to 1 μm and less than or equal to 100 μm. It should be noted that the term “height of each first reinforcing portion 6” refers to a dimension of each first reinforcing portion 6 protruding from the inner wall surface of each through hole 43 toward the center of each through hole 43.

Each first reinforcing portion 6 is made of a material higher in Young's modulus than the metallic plate 4. For example, each first reinforcing portion 6 is made of ceramics such as an oxide. More specifically, each first reinforcing portion 6 can be made of one selected from the group consisting of chromium oxide, iron oxide, and manganese oxide, a composite oxide composed of two or more of the group, glass ceramics, YSZ, GDC, or so forth.

It should be noted that each first reinforcing portion 6 may be made of a material identical to that of the oxide film provided on the inner wall surface of each through hole 43. In this case, a portion protruding with respect to the other portions is provided as each first reinforcing portion 6. In other words, each first reinforcing portion 6 has a height greater in magnitude than the thickness of the oxide film. Besides, the term “height of each first reinforcing portion 6” is herein defined as the height of each first reinforcing portion 6 from the inner wall surface of each through hole 43.

Besides, each first reinforcing portion 6 may be made of metal. For example, each first reinforcing portion 6 may be made of one selected from the group consisting of nickel, iron, cobalt, and copper, alloy of the one selected from the group, or so forth.

Each first reinforcing portion 6 can be formed by applying a reinforcing material paste onto the inner wall surface of each through hole 43 along the circumferential direction of each through hole 43 by a precision nozzle-equipped dispenser and then firing the reinforcing material paste. In addition to this, each first reinforcing portion 6 can be formed as well by locally heating the inner wall surface of each through hole 43 along the circumferential direction of each through hole 43 with laser irradiation such that a thick oxide film is deposited thereon.

It should be noted that it is preferable but not required for all the through holes 43 to be provided with the first reinforcing portions 6. For example, it is preferable for 50% or more of the through holes 43 to be provided with the first reinforcing portions 6. It should be noted that it is preferable for at least 10% or more of the through holes 43 to be provided with the first reinforcing portions 6.

### Modifications

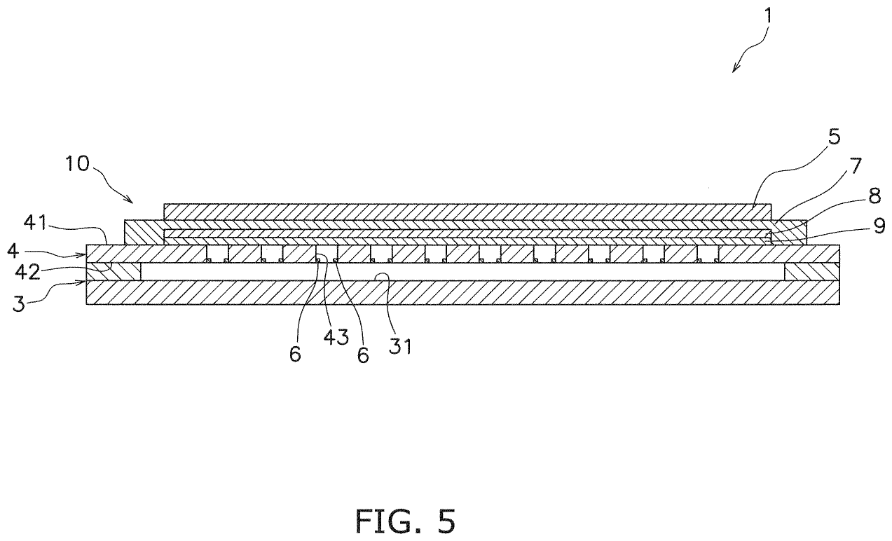

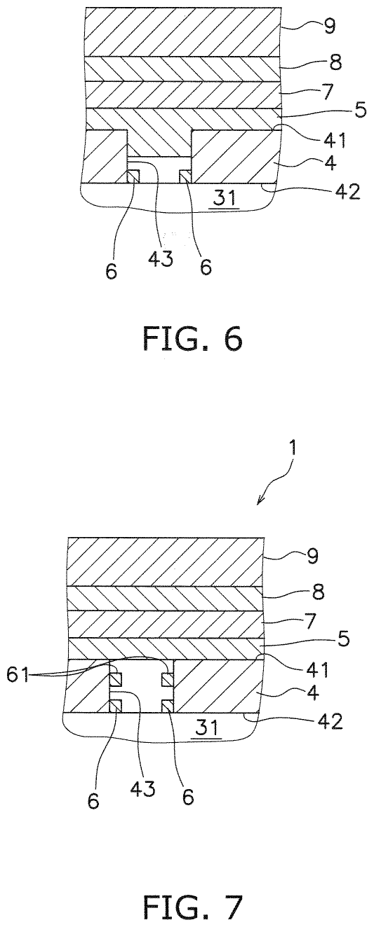

One preferred embodiment of the present invention has been explained above. However, the present invention is not limited to this, and a variety of changes can be made without departing from the gist of the present invention.
(a) In the preferred embodiment described above, the hydrogen electrode layer 5 is disposed on the metallic plate 4; however, the cell body 10 is not limited in configuration to this. For example, as shown in FIG. 5, the oxide electrode layer 9 may be disposed on the metallic plate 4. In this case, the oxide electrode layer 9, the reaction preventing layer 8, the electrolyte layer 7, and the hydrogen electrode layer 5 are sequentially disposed in this order from the same side as the metallic plate 4. The electrolyte layer 7 is provided to cover both the oxide electrode layer 9 and the reaction preventing layer 8. It should be noted that the reaction preventing layer 8 may not be provided.
(b) As shown in FIG. 6, the hydrogen electrode layer 5 may get in the through holes 43. In this case, as shown in FIG. 6, the hydrogen electrode layer 5 may be filled in only part of, or the entirety of, each through hole 43; alternatively, the hydrogen electrode layer 5 may protrude out of each through hole 43 toward the second principal surface 42.
(c) As shown in FIG. 7, the electrolytic cell 1 may further include second reinforcing portions 61. Each second reinforcing portion 61 is disposed closer to the first principal surface 41 than each first reinforcing portion 6. For example, each second reinforcing portion 61 is disposed in the middle of each through hole 43 in the axial direction of each through hole 43. Each second reinforcing portion 61 is disposed away from the hydrogen electrode layer 5 at an interval. Besides, each second reinforcing portion 61 is disposed away from each first reinforcing portion 6 at an interval.

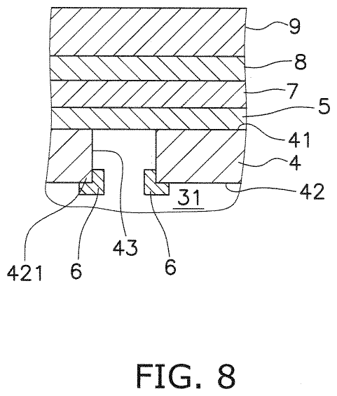

Each second reinforcing portion 61 is provided on the inner wall surface of each through hole 43 along the circumferential direction of each through hole 43 in a comparable manner to each first reinforcing portion 6. Each second reinforcing portion 61 may be set to be lower in height than each first reinforcing portion 6. Besides, each second reinforcing portion 61 is made of a material higher in Young's modulus than the metallic plate 4. Each second reinforcing portion 61 can be made of the same material as each first reinforcing portion 6. Furthermore, each second reinforcing portion 61 can be formed by a method comparable to that for forming each first reinforcing portion 6.
(d) In the preferred embodiment described above, each first reinforcing portion 6 is disposed on the end close to the second principal surface 42 in each through hole 43; however, each first reinforcing portion 6 is not limited in position to this. For example, each first reinforcing portion 6 may be disposed in the middle of each through hole 43 in the axial direction of each through hole 43, or alternatively, may be disposed in any other position.
(e) In the preferred embodiment described above, each first reinforcing portion 6 is not disposed on the second principal surface 42 of the metallic plate 4; however, each first reinforcing portion 6 is not limited in configuration to this. For example, as shown in FIG. 8, each first reinforcing portion 6 may be provided not only on the inner wall surface of each through hole 43 but also on the second principal surface 42. In this case, each first reinforcing portion 6 is disposed to cover a corner 421 composed of the inner wall surface of each through hole 43 and the second principal surface 42.
(f) In the preferred embodiment described above, the electrolytic cell 1 has been explained as an exemplary electrochemical cell; however, the electrochemical cell may be other than the electrolytic cell. For example, the electrochemical cell may be a fuel battery cell such as a solid oxide fuel battery. In this case, the first electrode layer can be set as a fuel electrode (anode), whereas the second electrode layer can be set as an air electrode (cathode).

### REFERENCE SIGNS LIST

1: Electrolytic cell
4: Metallic plate
41: First principal surface
42: Second principal surface
43: Through hole
5: Hydrogen electrode layer
6: First reinforcing portion
61: Second reinforcing portion
7: Electrolyte layer
9: Oxide electrode layer
10: Cell body

1. An electrochemical cell comprising:
a metallic plate including a first principal surface, a second principal surface, and a through hole;
a cell body including a first electrode layer, a second electrode layer, and an electrolyte layer disposed between the first electrode layer and the second electrode layer, the cell body disposed on the first principal surface of the metallic plate; and
a first reinforcing portion provided on an inner wall surface of the through hole along a circumferential direction of the through hole, the first reinforcing portion configured to reinforce the inner wall surface of the through hole.

2. The electrochemical cell according to claim 1, wherein the first reinforcing portion is made of a material higher in Young's modulus than the metallic plate.

3. The electrochemical cell according to claim 1, wherein the first reinforcing portion is disposed on an end close to the second principal surface on the inner wall surface of the through hole.

4. The electrochemical cell according to claim 1, wherein the first reinforcing portion is made in shape of an annulus.

5. The electrochemical cell according to claim 1, further comprising:
a second reinforcing portion disposed closer to the first principal surface than the first reinforcing portion, the second reinforcing portion provided on the inner wall surface of the through hole along the circumferential direction of the through hole, the second reinforcing portion configured to reinforce the inner wall surface of the through hole.

6. The electrochemical cell according to claim 5, wherein the second reinforcing portion is made of a material higher in Young's modulus than the metallic plate.

7. The electrochemical cell according to claim 5, wherein the second reinforcing portion is lower in height than the first reinforcing portion.

8. The electrochemical cell according to claim 1, wherein the first reinforcing portion is made of ceramics.

9. The electrochemical cell according to claim 1, wherein the first reinforcing portion is made of metal.
